(19) United States
(12) Patent Application Publication
(10) Pub. No.: US 2014/0251078 A1
(43) Pub. Date: Sep. 11, 2014

(54) Pedal Cleat System

(71) Applicants: Willard I. Emerson, Carbondale, CO (US); Neal Jay Beidleman, Aspen, CO (US); Peter G. Emerson, Burlington, VT (US); Jamie Emerson, Boulder, CO (US)

(72) Inventors: Willard I. Emerson, Carbondale, CO (US); Neal Jay Beidleman, Aspen, CO (US); Peter G. Emerson, Burlington, VT (US); Jamie Emerson, Boulder, CO (US)

(73) Assignee: Ultralitesports, LLC

(21) Appl. No.: 13/642,831

(22) PCT Filed: Jul. 8, 2012
(86) PCT No.: PCT/US12/45883

§ 371 Date: Oct. 22, 2012

Related U.S. Application Data
(60) Provisional application No. 61/629,647, filed on Nov. 23, 2011.

(51) Int. Cl. B62M 3/08; A43B 5/14

(52) U.S. Cl. CPC B62M 3/086; A43B 5/14
USPC 74/594.6

(57) ABSTRACT

A pedal and cleat system for cycling including a pedal having a post and a cleat having a post receiving element, the post receiving element of the cleat engages the post of the pedal to allow rotation of the cleat about the post to turn the crank arms of a cycle to propel the cycle's wheels.

This application is the United States National Stage of International Patent Corporation Treaty Patent Application No. PCT/US2012/045883, filed Jul. 8, 2012, which claims the benefit of U.S. Provisional Patent Application No. 61/629,647, filed Nov. 23, 2011, each hereby incorporated by reference herein.

### I. TECHNICAL FIELD

A cyclist reciprocally pushes and pulls the feet engaged to pedals to propel a cycle. Each pedal provides the connection between the cyclist's foot or shoe and the corresponding crank arm of the cycle to allow the leg to turn the bottom bracket spindle and propel the cycle's wheels.

### II. BACKGROUND

Conventional pedals usually consist of a spindle that threads into the end of the crank arm and a body on which the foot rests or is attached. The pedal is free to rotate on bearings with respect to the spindle. The body may comprise a platform with a relatively large flat area for the foot to engage or the body may comprise an axle with extensions from the axle to which cage plates attach at the front and rear of the body typically in parallel opposed relation.

Toe clips may be further included in the body of the pedal. A toe clip includes a thin metal or plastic member attached to the front cage plate. The toe of the cyclist's shoe inserts within the toe clip to resist slipping of the cyclist's shoe from the body of the pedal. The toe clip can further include an adjustable toe strap the length of which can be adjusted to wrap about the toe of the shoe.

The disadvantage of toe clips can be a lack of sufficient grip of the shoe on the pedal and the need to loosen the toe strap by hand to remove the toe of the shoe or leave the toe strap loose and lose some efficiency in securing the shoe to pedal.

Alternately, the cyclist's shoe can be modified to provide a cleat which includes a slot or a groove to engage one of the cage plates. A disadvantage of conventional cleats can be that engagement of the cleat with the pedal can take practice to engage and disengage the cleat from the pedal with proficiency.

A general disadvantage with conventional pedals, clips and cleats can be the amount of weight or accelerated weight is not minimized. Accordingly, every time the pedal spin rate is changed, the excess weight must be accelerated using up the cyclist's energy.

The instant invention provides a pedal cleat system and method of using a pedal cleat system which affords advantages and addresses the disadvantages related to conventional pedals, toe clips and cleats.

### III. DISCLOSURE OF THE INVENTION

Accordingly, a broad object of particular embodiments of the invention can be to provide an inventive pedal and an inventive cleat which in combination provide a pedal cleat assembly for a cycle. Particular embodiments of the invention include a pedal having spindle, and a post coupled around a part of the spindle to provide a post external surface for engagement inside of a post receiving element of a cleat. The pedal cleat assembly allows rotation of the cleat around the longitudinal axis of the pedal. A shoe can be fastened to the cleat to make the cleat responsive to movement of a cyclist's foot. Movement of the foot in the shoe can be transferred through the pedal cleat assembly to turn the crank arms of the cycle which correspondingly turn the bottom bracket spindle and propel the cycle's wheels.

Another broad object of particular embodiments of the invention can further provide a pedal retainer which retains engagement of the post to the cleat. Particular embodiments of the pedal retainer include a pair of tangs coupled to the post receiving element disposed in opposed relation a distance apart such that the post external surface upon aligned engagement inside of the post receiving element has a location beneath the pair of tangs. The pair of tangs engage the post external surface to retain the post inside of the post receiving element. Offset alignment of the post external surface inside of the post receiving element allows a part of the spindle of the pedal to pass between the pair of tangs to release engagement of the post external surface from inside of the post receiving element. As to other particular embodiments, the pedal retainer can further include an annular member coupled about the post external surface proximate the outboard end (also referred to as the “second end”) of the pedal for engagement with an annular member receiving element which restricts outboard movement of the cleat in relation to the pedal. Particular embodiments can further include a tubular sleeve slidingly coupled about the spindle between the post and the inboard end (also referred to as the “first end”) of the pedal. The tubular sleeve can be responsive to a spring element which forcibly urges the tubular sleeve toward the post to engage the cleat thereby restricting inboard movement of the cleat in relation to the pedal.

Another substantial object of the invention can be to provide method of cycling in which the post external surface of a pedal engages a post receiving element of a cleat. The action of pedaling causing the cleat to rotate about the post external surface to turn the crank arms of the cycle which correspondingly turns the bottom bracket spindle to propel the cycle's wheels.

Naturally, further objects of the invention are disclosed throughout other areas of the specification, drawings, photographs, and claims.

### III. BRIEF DESCRIPTION OF THE DRAWINGS

FIG. 1 is an illustration of a method of using an embodiment the pedal cleat assembly.

FIG. 2 is a perspective view of a particular embodiment of the pedal cleat assembly with the cleat disengaged from the pedal.

FIG. 3 is a perspective view of a particular embodiment of the pedal cleat assembly with the pedal positioned for engagement of a post external surface with a post receiving element of the cleat.

FIG. 4 top plan view of a particular embodiment of the pedal cleat assembly with the post external surface engaged in offset alignment with the post receiving element which allows a part of the spindle to pass between a pair of tangs for engagement or disengagement of the post with the cleat.

FIG. 5 is a perspective view of a particular embodiment of the pedal cleat assembly with the post external surface having aligned engagement inside of the post receiving element which engages the post external surface with a pair of tangs to retain the post external surface inside of said post receiving element.

FIG. 6 is an exploded view of a particular embodiment of the pedal cleat assembly.

FIG. 7 is a perspective view of a particular embodiment of the cleat.

FIG. 8 is top view of the particular embodiment of the cleat.

FIG. 9 is a front view of the particular embodiment of the cleat.

FIG. 10 is a rear view of a particular embodiment of the cleat.

FIG. 11 is a first side view of the particular embodiment of the cleat.

FIG. 12 is a second side view of the particular embodiment of the cleat.

FIG. 13 is a bottom view of the particular embodiment of the cleat.

FIG. 14 is a side view of a particular embodiment of the pedal.

FIG. 15 is a first end view of the particular embodiment of the pedal.

FIG. 16 is second end view of the particular embodiment of the pedal.

FIG. 17 is cross section 17-17 of the pedal as shown in FIG. 14.

### V. MODE(S) FOR CARRYING OUT THE INVENTION

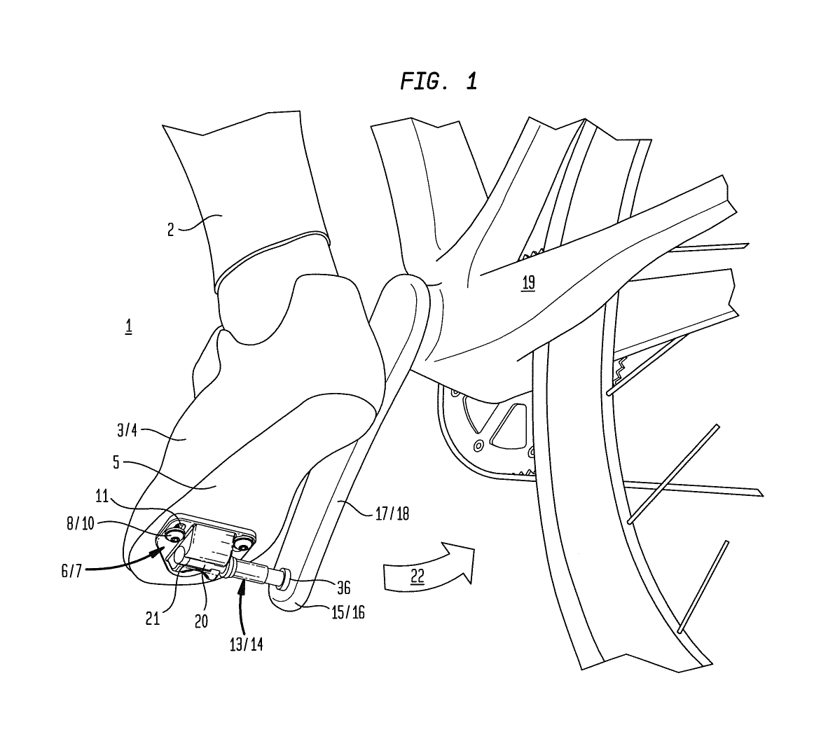

Now referring primarily to FIG. 1, which illustrates a method of using a particular embodiment of a pedal cleat system (1), a cyclist (2) can obtain a pair of shoes (3)(4)(one of the pair shown) each having a sole (5) adapted for attachment of a corresponding pair of cleats (6)(7)(one of the pair shown) in accordance with the invention and further described below. Typically, the pair of shoes (3)(4) are purpose-built for cycling and can include a numerous and wide variety of upper shoe and sole designs depending on the type and intensity of cycling. However, the pair of shoes (3)(4) encompasses shoes that may not be purpose-built for cycling but can be adapted for attachment of a corresponding pair of cleats (6)(7) configured in accordance with the invention.

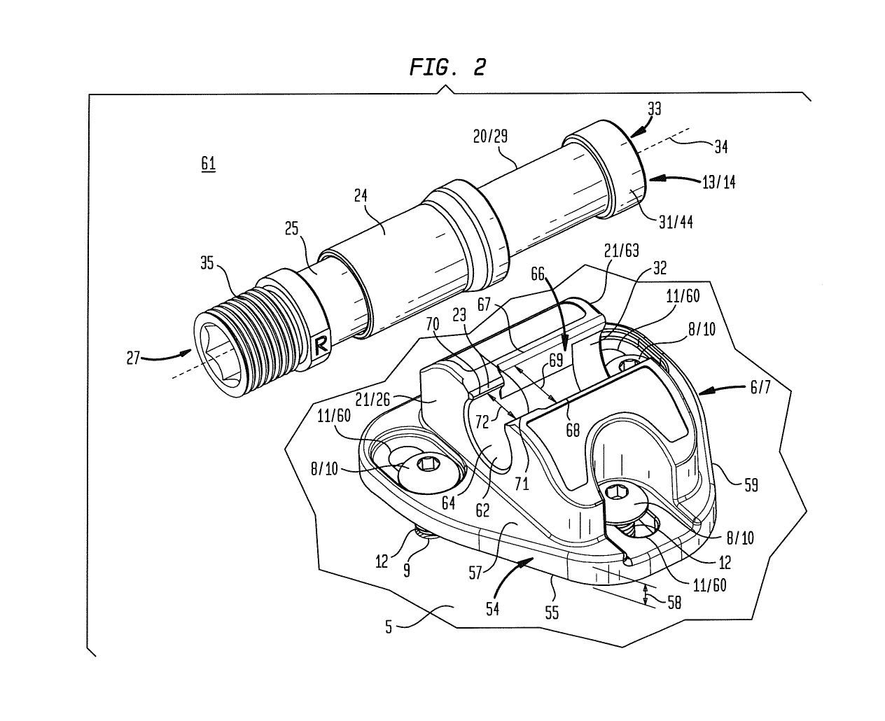

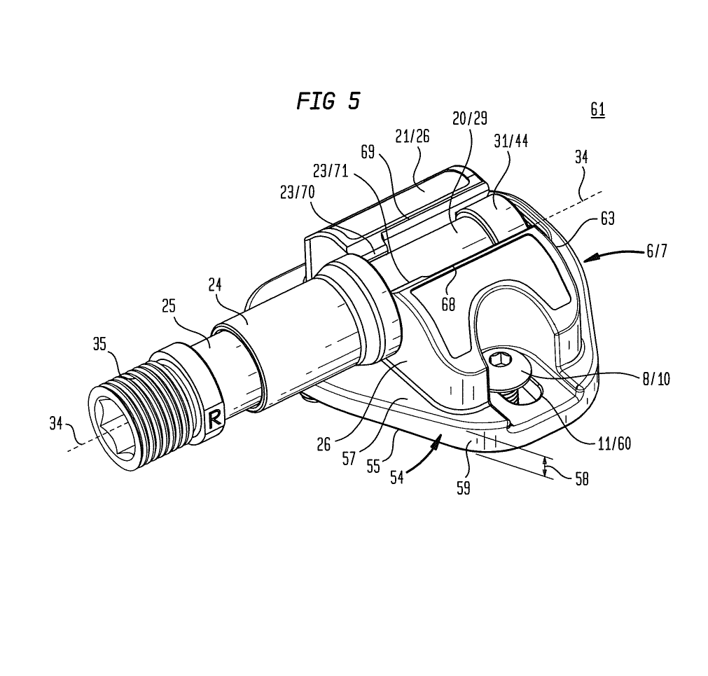

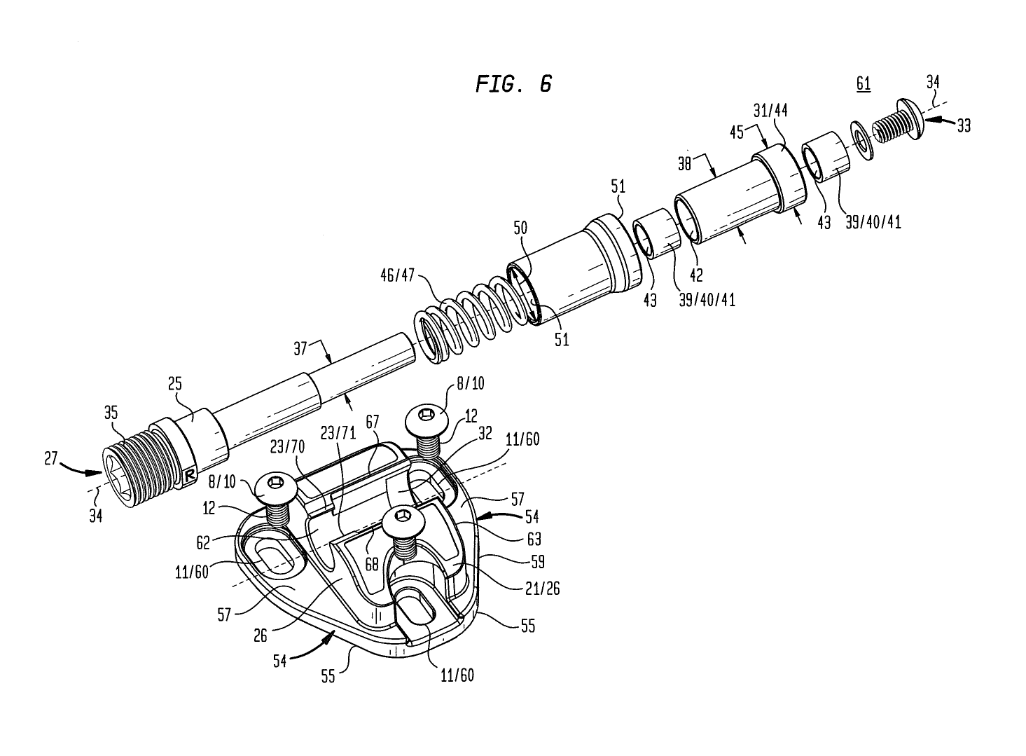

One of the pair of cleats (6)(7) can be attached to the corresponding one of the pair of shoes (3)(4) by mechanical fasteners (8)(as shown in the example of FIG. 1). Typically, the sole (5) of each of the pair of shoes (3)(4) provides one or more threaded holes (9) each of which can receive a corresponding threaded fastener (10)(as shown in the example of FIG. 2). Each of the pair of cleats (6)(7) can have one or more mounting apertures (11)(as shown in the example of FIG. 6) having a spatial relation which aligns the one or more threaded holes (9) of the sole (5) with the corresponding one or more mounting apertures (11) of the cleat (6). A threaded fastener (10) passes through a corresponding one of the mounting apertures (11)(as shown in the examples of FIGS. 1 through 6). The threads (12) of each threaded fastener (10) can be rotatingly mated with corresponding threads (13) of the threaded holes (9) to secure each of the pair of cleats (6)(7) to a corresponding sole (5) of the pair of shoes (3)(4).

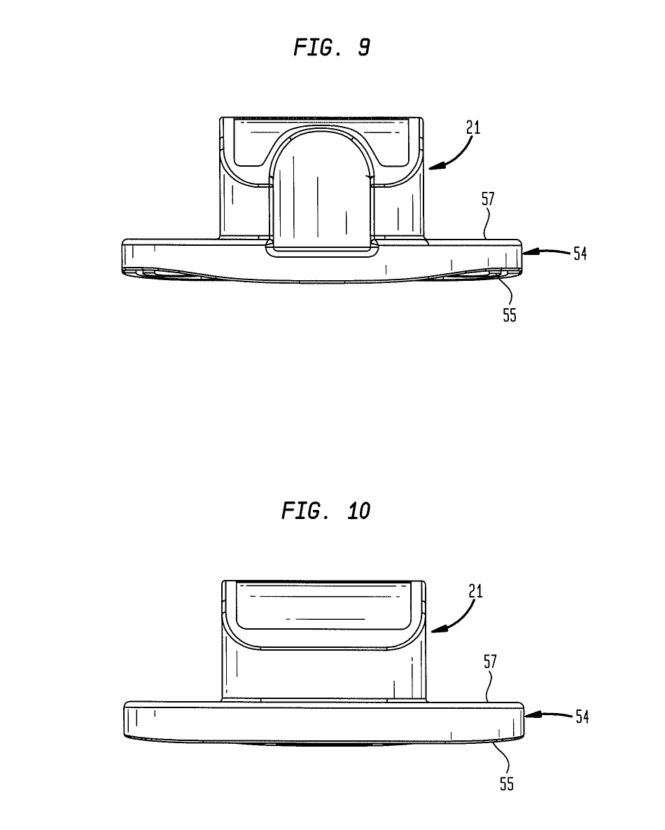

Again referring primarily to FIG. 1, a pair of pedals (13)(14)(one of the pair shown) configured in accordance with the invention as further described below, can be coupled proximate a corresponding pair of first crank arm ends (15)(16)(one of the pair shown) of a pair crank arms (17)(18)(one of the pair shown) of a cycle (19). However, it is not intended that use of the inventive pedals be limited to a pair of pedals (13)(14) or be limited to cycles (19) having two crank arms (17)(18) and one, two or more inventive pedals can be used with a corresponding number of inventive cleats (6)(7) depending upon the application. The inventive pair of pedals (13)(14) can each in part include a post (20)(as shown in the examples of FIGS. 1 through 6), as further described below. The inventive pair of cleats (6)(7) can each in part include a post receiving element (21) (as shown in the examples of FIGS. 2 through 11), as further described below. The post receiving element (21) can further include one, a pair, or more than one pair of opposed pairs of tangs (23)(as shown in the examples of FIGS. 2 through 13).

Again referring primarily to FIG. 1, generally, the cyclist (2) wears the pair of shoes (3)(4) having a corresponding pair of cleats (6)(7) attached to the soles (5). As to particular embodiments of the invention, the cyclist (2) aligns the post receiving element (21) with the post (20) of the corresponding one of the pair of pedals (13)(14). Each post (20) can be located within the corresponding post receiving element (21) to allow rotatable engagement of each one of the pair of cleats (6)(7) about each one of the corresponding pair of posts (20) resulting in a pedal cleat assembly (61) (as shown in the examples of 2 through 5).

As to particular embodiments, the post receiving element (21) can be sufficiently forcibly urged (22) against the post (20) to allow the post (20) to be received within the post receiving element (21). As to particular embodiments, the one or more tangs (23) of the post receiving element (21) can be sufficiently forcibly urged against the post (20) to allow the post (20) to be received within the post receiving element (21) by generating sufficient flexure in the (6)(7) or in the one or more tangs (23).

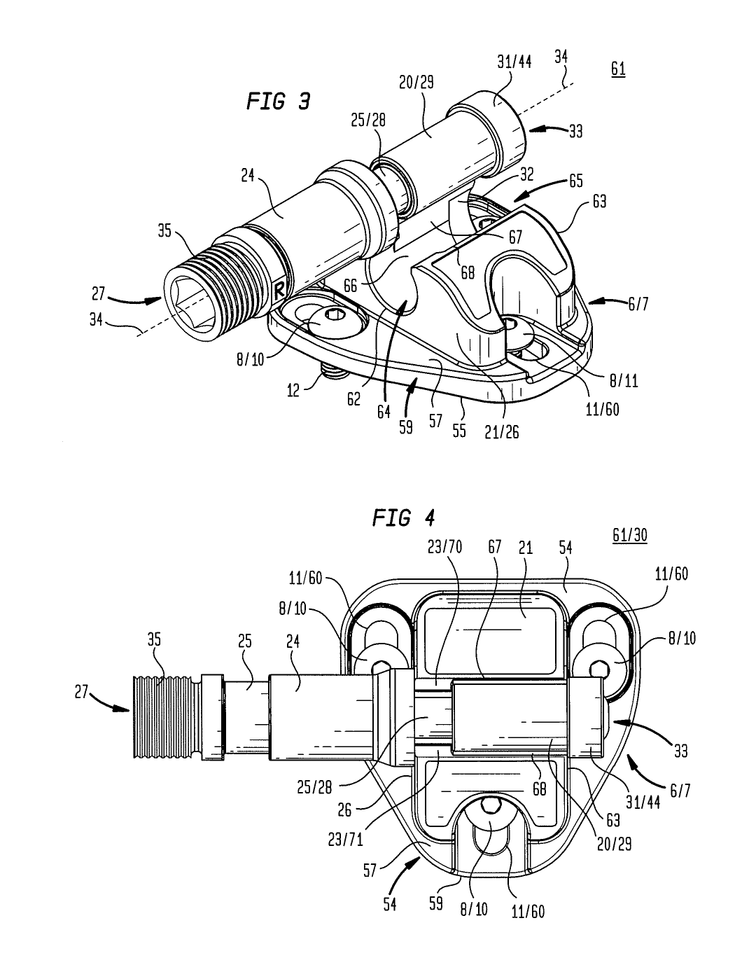

As to other embodiments (as shown in examples of FIGS. 2 through 5), the cyclist (2) can position the pedal (13) in relation to the cleat (6)(as shown in the example of FIG. 2). A tubular sleeve (24) slidably coupled about a spindle (25) of the pedal (13) can be engaged against a first side (26) of the post receiving element (21) to forcibly urge the tubular sleeve (25) toward a first end (27) of the spindle (25) to expose a portion (28) of the spindle (25)(as shown in the example of FIG. 3). The exposed portion (28) of the spindle (40) can be passed between the pair of tangs (23) to engage a post external surface (29) in offset alignment (30) inside of said post receiving element (21)(as shown in the example of FIG. 4). The cyclist (2) can then slidably align the post (20) inside of the post receiving element (21) to locate a part of the post (20) beneath the pair of tangs (23), thereby retaining the post (20) aligned inside of the post receiving element (21) by engagement of the post external surface (29) with the pair of tangs (23)(as shown in the example of FIG. 5). As to certain embodiments, alignment of the post (20) inside of the post receiving element (21) can further engage an annular member external surface (44) coupled about the post external surface (29) inside of a corresponding annular member receiving element (32)(as shown in the example of FIG. 5) which prevents further inboard axial longitudinal movement of the post (20) inside of the post receiving element (21). As to certain embodiments, the tubular sleeve (24) can be slidably engaged against the first side (26) of the cleat (13) to resist outboard axial longitudinal movement of the post (20) inside of the post receiving element (21)(as shown in the example of FIG. 5).

Again referring primarily to FIG. 1, rotation of the post (20) inside of the post receiving element (21) allows alternating reciprocal forcible urging (22) by the cyclist (2) against the pair of pedals (13)(14) to rotate the corresponding pair of crank arms (17)(18) of the cycle (19) to allow the leg to turn the bottom bracket spindle and propel the bicycle's wheels.

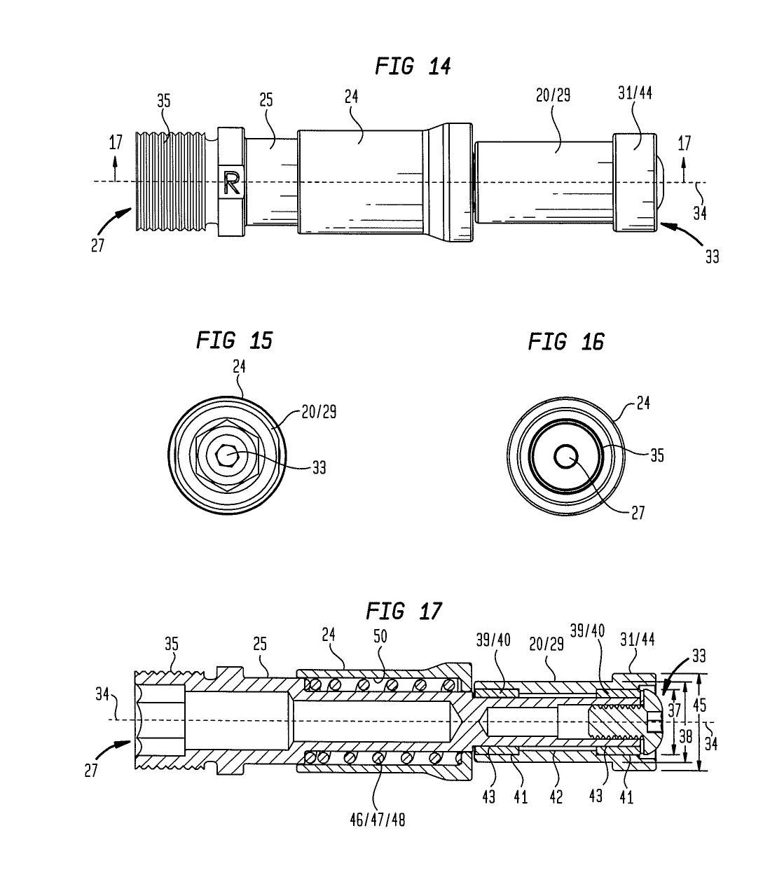

Now referring to primarily to FIG. 6 and FIGS. 14 through 17, particular embodiments of the invention include an inventive pedal (13) and while only the right handed embodiment is shown; it is intended that the basic elements of the pedal (13) can be incorporated into left handed embodiments, right handed embodiments, or even ambidextrous embodiments. The pedal (13) can provide a spindle (25) having length between a first end (27) and a second end (33) defining the longitudinal axis (34) of the pedal (13). The first end (27) can be adapted to couple to a first crank arm end (15). While the Figures show the first end (27) having a spiral thread (35) which rotationally mates with a corresponding spirally threaded bore (36) of the first crank arm end (15); the invention is not so limited, and the spindle (25) can be coupled to the first crank arm end (15)(as shown in the example of FIG. 1) by any form of coupling which attaches the first end (27) of the spindle (25) in fixed relation to the first crank arm end (15).

A post (20) configured to mate with the post receiving element (21) can be coupled about the spindle (25) proximate the second end (33) of the spindle (25)(as to certain embodiments, the spindle (25) and the post (20) can be produced as one piece and as to other embodiments the spindle (25) can insert inside of a removably coupled post (20)(as shown in the example of FIG. 6). The post (20) coupled about the spindle (25) proximate the second end (33) can have a post external surface (29) for engagement within a post receiving element (21) of a cleat (6). The spindle (25) and the post external surface (29) can each have a generally cylindrical form with the spindle (25) having a spindle diameter (37) that is less than the post external surface diameter (38) (as shown in the examples of FIGS. 6 and 17).

As to particular embodiments, the post (20) coupled about the second end (33) of the spindle (25) rotates about the longitudinal axis (34) of the pedal (13). To facilitate rotation of the post (20) around the spindle (25), the second end (33) of the spindle (25) can be journaled in one or more bearing elements (39), such as one or more bushings (40)(as shown in the example of FIG. 6), roller bearings, or the like, which provide an external bearing surface (41) engaged with a post internal surface (42) and an internal bearing surface (43) engaged with the spindle (25). The post (20) can further include an annular member (31) coupled about the post external surface (29) proximate the second end (33) of the spindle (25) for engagement within an annular member receiving element (32) of the cleat (6) upon aligned engagement of the post external surface (29) inside of the post receiving element (32)(as shown in the example of FIG. 4). The post external surface (32) and the annular member external surface (44) can each have a generally cylindrical form with the post external surface diameter (38) being less than the annular member external surface diameter (45)(as shown in the example of FIG. 6)

Again referring primarily to FIG. 6 and FIGS. 14 through 17, particular embodiments of the pedal (13) can further include a tubular sleeve (24) slidably coupled about the spindle (25)(as shown in the example of FIG. 17). The tubular sleeve (24) can be moved toward the first end (27) of the spindle (25) to expose a portion (28) of the spindle (25) adjacent the post (20) and be moved toward the second end (33) of the spindle (25) adjacent the post (20) to cover the portion (28) of the spindle adjacent the post (20). A spring element (46) can engage the tubular sleeve (24) to forcibly urge the tubular sleeve (24) toward the post (20). Forcible urging to compress the spring element (46) allows the tubular sleeve (24) to move toward the first end (27) of the spindle (25). As to particular embodiments of the pedal (13), a part of the spindle (25) can be located inside the coils (47) of a coil spring (48) (as shown in the example of FIG. 17). The tubular sleeve (24) can have a sufficiently large tubular sleeve internal diameter (49) to allow sliding engagement of the tubular sleeve internal surface (50) of the tubular sleeve (24) about the coils (47) of the coil spring (48). Forcible urging of the tubular sleeve (24) toward the first end (27) sufficiently compresses the coil spring (48) to expose the portion (28) of the spindle (25) adjacent the post (20). The tubular sleeve (24) can further include an annular end cap (51) having an aperture (52) of sufficient aperture diameter (53) to allow the spindle (25) to pass through but of insufficient aperture diameter (53) to allow the post external surface (29) to pass through. Accordingly, decompression of the coil spring (48) returns the tubular sleeve (24) to engage the annular end cap (51) against the post (20) (as shown in the example of FIG. 17).

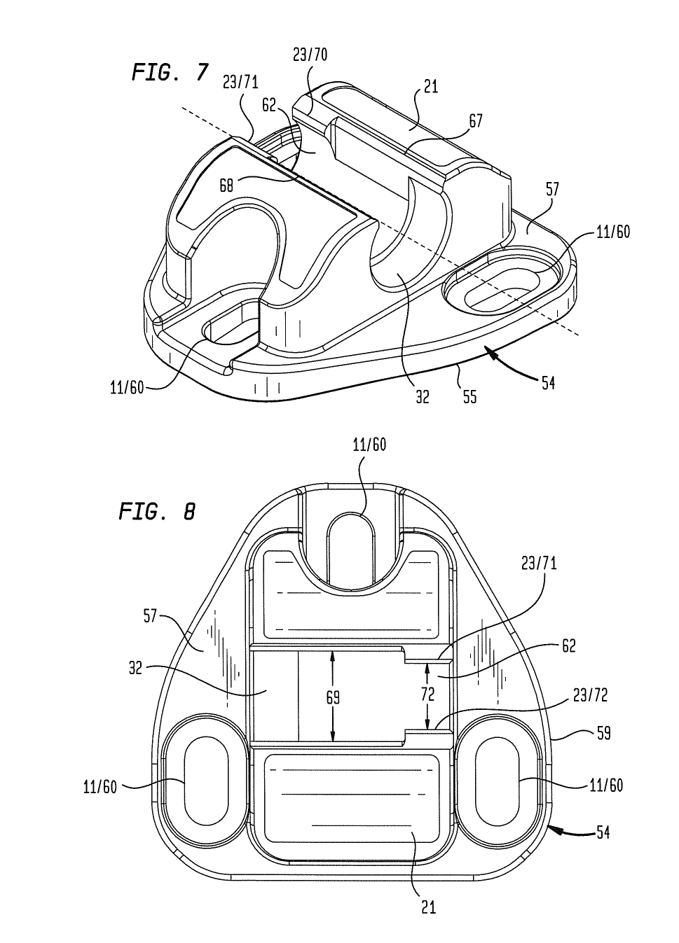

Now referring primarily to FIGS. 7 through 13, embodiments of the invention include an inventive cleat (6), and while only the right handed embodiment is shown; it is intended that the basic elements of the cleat (6) can be incorporated into left handed embodiments, right handed embodiments, or even ambidextrous embodiments. The cleat (6) can be produced, fabricated, molded, cast or otherwise produced from numerous and varied materials such metal (for example aluminum or brass), plastic overmolded on a metal frame, plastic (for example nylon, polyamide plastic such as VESPEL, glass filled nylon), plastic impregnated carbon fiber, or the like. Particular embodiments can be injection molded from an injection moldable plastic such as polyoxymethylene (also known as “DELRIN”); however, the invention is not so limited.

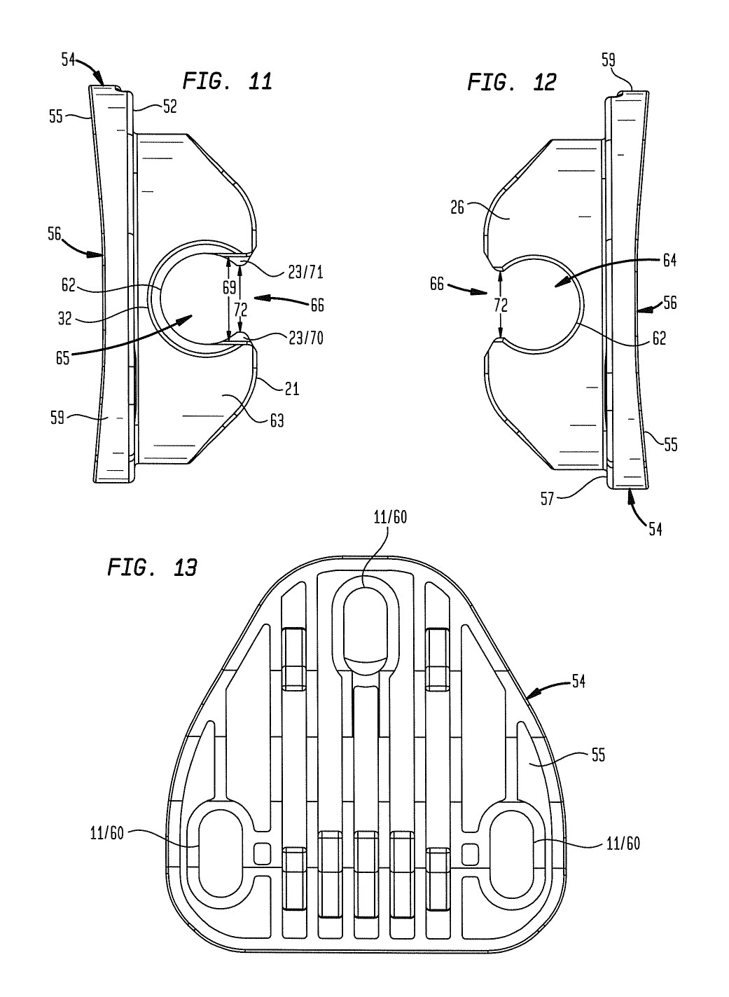

Particular embodiments of the cleat (6) include a mount element (54) having a bottom face (55)(as shown in the example of FIG. 13) adapted to engage the sole (5) of a shoe (3), as above described. While the bottom face (55) can include a substantially flat surface, the invention is not so limited and the bottom face (55) can be configured to provide a curved surface (56)(as shown in the examples of FIGS. 11 and 12), or otherwise, to facilitate attachment to the shoe (3) depending upon the application. The mount element (54) further includes a top face (57) disposed a thickness (58) apart from the bottom face (55). The thickness (58) can vary depending upon the material from which the cleat (6) is made, but in any event sufficient to provide a structure sufficiently supportive to allow operation of the cleat (6) for the intended purpose. The top face (57) can also be substantially flat (as shown in the examples of FIGS. 11 and 12); however, the invention is not so limited. The mount element (54) can define a periphery (59) which bounds an area sufficient as to the top face (57) to centrally couple a post receiving element (21) and further provide sufficient area to bound one or more mounting apertures (11) which communicate between the top face (27) and the bottom face (26). The mounting apertures (11) can be located in a numerous and wide variety of patterns to accommodate a correspondingly numerous and wide variety of attachment patterns in shoes (3)(4) made for cycling. As to certain embodiments, the mounting apertures (11) can take the form of an elongated slot (60)(as shown in the examples of FIGS. 7 and 8) which allows the cleat (6) to be adjustably positioned a greater or lesser distance from the toe of the shoe (3) and to an extent rotated in relation to the sole (5) of the shoe (3); however, other structural forms can be utilized which allow attachment and adjustment of the cleat (6) to the sole (5) of the shoe (3). The periphery (59) of the mounting element (54) while shown in the Figures as defining five sides (generally rectangular proximate the heel of the shoe (3) and tapering inwardly toward the toe of the shoe (3)) is not so limited and the periphery (59) can bound a mount element (54) having any dimensional relations which allows securement of the mount element (54) to the sole (5) of a shoe (3) and allows the intended operation of the shoe (3) in association with the cleat (6) and the pedal cleat assembly (61)(as shown in the example of FIG. 5). As to certain embodiments the sole (5) or the shoe (3) can be made one piece with the cleat (6).

Now referring primarily to FIGS. 7, 8, 11 and 12, the cleat (6) can further provide a post receiving element (21) for engagement of the post external surface (29) of the pedal (13). The post receiving element (21) can be coupled to the top face (57) of the mount element (54) whether by mechanical fasteners, bonding agent, or by fabrication, molding or other production process or to provide a one piece mount element (54) and post receiving element (21). The post receiving element (21) can define a channel (62) which communicates between at the first side (26) and the second side (63) of the post receiving element (21) in a first channel end opening (64) and a second channel end opening (65)(as shown by the examples of FIGS. 11 and 12). The channel (62) further defines an elongate opening (66) between the first channel end opening (64) and the second channel end opening (65)(as shown in the examples of FIGS. 7 and 8). Particular embodiments of the post receiving element (21) can define a generally cylindrical channel (62) for engagement with a generally cylindrical post external surface (29).

Now referring primarily to FIG. 8, the opposed sides (67)(68) of the channel (62) at the elongate opening (66) can be disposed a distance apart (69) in the top of the post receiving element (21) between the first channel end opening (64) and the second channel end opening (65)(as shown the example of FIG. 8). As to particular embodiments, the distance apart (69) between the opposed sides (67)(68) of the channel (62) at the elongate opening (66) can be less than the diameter of the post external surface (28). As to these embodiments, the mount element (54) or the post receiving element (21)(or both) can have sufficient resilient flexure to achieve, upon forcible urging of the post (20) longitudinally aligned with the elongate opening (66), a flexed condition which increases the distance between the opposed sides (67)(68) of the channel (62) which allows the post (20) to pass into the channel (62). The post receiving element (21) can then return to the unflexed condition to retain the post (20) within the channel (62). Sufficient forcible urging of the post receiving element (21) away from the post (20) causes the post (20) to be drawn through the elongate opening (35) to separate the post (20) from the post receiving element (21).

As to particular embodiments, the post receiving element (21) can be substantially in flexible. Portions of the opposed sides (67)(68) of the channel (62) at the elongate opening (66) can define one or more tangs, a pair of tangs (or one or more pairs of tangs)(23). As shown in the example of FIG. 8, a pair of tangs (70)(71) can be disposed in opposed relation a distance apart (72). The distance apart (72) between the pair of tangs (70)(71) can be less than the post external surface diameter (38) but a greater than the spindle diameter (37) of the portion (28) of the spindle (25) proximate the post (20). Offset alignment of the post (20) in relation to the post receiving element (21) allows the portion (28) of the spindle (25) to pass between the pair of tangs (70)(71) to engage the post external surface (29) in offset alignment inside of said post receiving element (21)(as shown in the example of FIG. 4). Subsequent aligned engagement of the post external surface (29) inside of the post receiving element (21) engages the post external surface (29) with the pair of tangs (70)(71) to retain the post (20) inside of the post receiving element (21).

As to particular embodiments, the post receiving element (21) further comprises an annular member receiving element (32) for engagement with the annular member external surface (44) upon aligned engagement of the post external surface (29) inside of the post receiving element (21) (as shown in the examples of FIGS. 7 and 8). The annular member receiving element (32) can be co-axially disposed in relation to channel (62) and disposed to communicate with the second side (63) of the post receiving element (21) in an annular member receiving element opening (73). The annular member receiving element (32) can have a generally cylindrical form for engagement with an annular member external surface (44) having a generally cylindrical form. The annular member external surface (44) can have annular member external surface diameter (45) greater than said post external surface (29). The annular member external surface (44) engaged inside of the annular member receiving element (32) restricts axial movement of the post (20) toward the first end (27) of the spindle (25).

As can be easily understood from the foregoing, the basic concepts of the present invention may be embodied in a variety of ways. The invention involves numerous and varied embodiments of an inventive pedal (13), an inventive cleat (6) and a pedal cleat assembly (61) which can be used in various forms of a pedal cleat system (1) and methods of using the inventive pedal cleat assembly (61). While the description and figures provide examples in the context of cycling or propelling a cycle (19); the invention is not so limited, and the each of the inventive pedal, inventive cleat, and the inventive pedal cleat assembly (1) can be utilized in other applications which require propulsion of a crank arm or similar constructional form.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of “a pedal” should be understood to encompass disclosure of the act of “pedaling”—whether explicitly discussed or not—and, conversely, were there effectively disclosure of the act of “pedaling”, such a disclosure should be understood to encompass disclosure of a “pedal” and even a “means for pedaling.” Such alternative terms for each element or step are to be understood to be explicitly included in the description.

In addition, as to each term used it should be understood that unless its utilization in this application is inconsistent with such interpretation, common dictionary definitions should be understood to be included in the description for each term as contained in the Random House Webster's Unabridged Dictionary, second edition, each definition hereby incorporated by reference.

Moreover, for the purposes of the present invention, the term “a” or “an” entity refers to one or more of that entity; for example, “a light source” refers to one or more of those light sources. As such, the terms “a” or “an”, “one or more” and “at least one” can be used interchangeably herein.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result. Similarly, the antecedent “substantially” means largely, but not wholly, the same form, manner or degree and the particular element will have a range of configurations as a person of ordinary skill in the art would consider as having the same function or result. When a particular element is expressed as an approximation by use of the antecedent “substantially,” it will be understood that the particular element forms another embodiment.

Thus, the applicant(s) should be understood to claim at least: i) each of the pedal cleat devices herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

The claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. A pedal for a pedal cleat assembly, comprising:
a) a spindle having a length disposed between a first end and a second end, said spindle defining the longitudinal axis of said pedal; and
b) a post coupled about said spindle proximate said second end, said post having a post external surface for engagement within a post receiving element of a cleat, said post receiving element having a pair of tangs disposed in opposed relation a distance apart between which said spindle passes to engage said post external surface in offset alignment inside of said post receiving element, wherein said pair of tangs retain said post external surface inside of said post receiving element upon aligned engagement of said post external surface inside of said post receiving element.

2. The pedal for a pedal cleat assembly of claim 1, wherein said spindle and said post external surface each have a generally cylindrical foam, said spindle having a lesser diameter than said post external surface.

3. The pedal for a pedal cleat assembly of claim 1, further comprising an annular member coupled about said post external surface proximate said second end of said spindle for engagement within an annular member receiving element of said cleat upon aligned engagement of said post external surface inside of said post receiving element.

4. The pedal for a pedal cleat assembly of claim 1, further comprising a tubular sleeve slidably coupled about said spindle, said tubular sleeve movable toward said first end of said spindle to expose a portion of said spindle which passes between said pair of detents to engage said post external surface in offset alignment inside of said post receiving element.

5. The pedal for a pedal cleat assembly of claim 4, further comprising a springing element which forcibly urges said tubular sleeve toward said post.

6. The pedal for a pedal cleat assembly of claim 1, wherein said first end of said spindle couples to a crank arm of a cycle.

7. The pedal for a pedal cleat assembly of claim 2, wherein said post coupled about said second end of said spindle rotates about the longitudinal axis of said pedal.

8. A cleat for a pedal cleat assembly, said cleat rotating around a longitudinal axis of a pedal, said cleat comprising:
a) a post receiving element disposed in said cleat for engagement of a post external surface of said pedal; and
b) a pair of tangs coupled to said post receiving element in opposed relation a distance apart between which a spindle of said pedal passes to engage said post external surface in offset alignment inside of said post receiving element, and wherein said pair of tangs retain said post external surface inside of said post receiving element upon aligned engagement of said post external surface inside of said post receiving element.

9. The cleat for a pedal cleat assembly of claim 8, wherein said post receiving element further comprises an annular member receiving element for engagement with an annular member coupled around said post external surface upon aligned engagement of said post external surface inside of said post receiving element.

10. The cleat for a pedal cleat assembly of claim 9, wherein said post receiving element has a generally cylindrical form for engagement with said post external surface having a general cylindrical form.

11. The cleat for a pedal cleat assembly of claim 10, wherein said annular member receiving element has a generally cylindrical form for engagement with said annular member having a generally cylindrical foam, said annular member having a diameter greater than said post external surface.

12. The cleat for a pedal cleat assembly of claim 12, further comprising a mount element coupled to said post receiving element for fastening said cleat to a shoe.

13. A pedal cleat assembly, comprising:
a) a pedal, including:
i) a spindle having a length disposed between a first end and a second end, said spindle defining the longitudinal axis of said pedal;
ii) a post coupled about said spindle proximate said second end, said post having a post external surface; and
b) a cleat, including:
i) a post receiving element configured for engagement of said post external surface of said pedal; and
ii) a pair of tangs coupled to said post receiving element in opposed relation a distance apart between which said spindle of a pedal passes to engage said post external surface in offset alignment inside of said post receiving element, and wherein said pair of detents retain said post external surface inside of said post receiving element upon aligned engagement of said post external surface inside of said post receiving element, said cleat engaged to said pedal rotates around said longitudinal axis of said pedal.

14. The pedal cleat assembly of claim 13, wherein said spindle and said post external surface each have a generally cylindrical form, said spindle having a lesser diameter than said post external surface.

15. The pedal cleat assembly of claim 13, further comprising an annular member coupled about said post external surface proximate said second end of said spindle, said annular member having an annular member external surface of greater diameter than said post external surface.

16. The pedal cleat assembly of claim 14, wherein said post rotatably couples about said second end of said spindle.

17. The pedal cleat assembly of claim 14, further comprising a tubular sleeve slidably coupled about said spindle between said first end of said spindle and said post, said tubular sleeve movable toward said first end of said spindle to expose a portion of said spindle which passes between said pair of tangs to engage said post external surface in offset alignment inside of said post receiving element.

18. The pedal cleat assembly of claim 17, further comprising a springing element engaged with said tubular sleeve slidably couple about said spindle which forcibly urges said tubular sleeve toward said post.

19. The pedal cleat assembly of claim 15, further comprising an annular member receiving element coupled to said post receiving element to engage said annular member upon aligned engagement of said post external surface inside of said post receiving element.

20. The pedal cleat assembly of claim 19, wherein said post receiving element and said post external surface each have a generally cylindrical form.

21. The pedal cleat assembly of claim 13, further comprising mount element coupled to said post receiving element for fastening said cleat to a shoe.

22. The pedal cleat assembly of claim 13, wherein said first end of said spindle couples to a crank arm of a cycle.

23-41. (canceled)
